(19) United States
(12) Patent Application Publication
(10) Pub. No.: US 2009/0103917 A1
(43) Pub. Date: Apr. 23, 2009

(54) Bidirectional HDCP-based data transmission apparatus using single optical fiber

(75) Inventor: Yu Wen-Ping, Taipei County (TW)

Correspondence Address: REED SMITH LLP, Suite 1400, 3110 Fairview Park Drive, Falls Church, VA, 22042, US

(73) Assignee: Amtran Technology Co., Ltd.

(21) Appl. No.: 12/007,765

(22) Filed: Jan. 15, 2008

(30) Foreign Application Priority Data
Oct. 19, 2007 (TW) 096139091

(51) Int. Cl. H04B 10/24

(52) U.S. Cl. 398/41

(57) ABSTRACT

The present invention provides a bidirectional HDCP-based data transmission apparatus using an optical fiber which includes a core having a first facet and a second facet. The bidirectional HDCP-based data transmission apparatus includes a forward transmission module and a backward transmission module. The forward transmission module is used for emitting at least two forward light signals into a first end of a core of the optical fiber when being driven. Afterward, the at least two forward light signals are transmitted over the optical fiber immediately. The backward transmission module is used for receiving the at least two forward light signals transmitted over the optical fiber and emitting at least one backward light signal into a second end of the core of the optical fiber when being driven. Then, the backward light signal is immediately transmitted over the optical fiber, wherein the forward transmission module also receives the at least one backward light signal transmitted over the optical fiber.

### BACKGROUND OF THE INVENTION

1. Field of the Invention

The invention relates to a data transmission apparatus which only uses one optical fiber, and more particularly, to a bidirectional HDCP-based data transmission apparatus.

2. Description of the Prior Art

HDCP (high-bandwidth digital content protection) is a digital rights management specification developed by Intel Corporation to protect digital entertainment traveled across DVI (digital visual interface) or HDMI (high definition multimedia interface) connections from being illegally copied. The HDCP specification provides a robust, cost-effective and transparent method for transmitting and receiving digital entertainment content to DVI/HDMI-compliant digital displays (e.g., high definition television or flat panel such as plasma, LCD and/or DLP, etc).

In general, HDCP encrypts the transmission of digital content between the video source and the digital display. And, HDCP is not designed to prevent copying or recording of the digital content per se, but rather designed to protect the integrity of content during transmission. The video source or transmitter could be, for instance, a DVD player, a computer, or a set-up box. The digital display or receiver could be, for instance, a digital television, a monitor, or a projector. The implementation of HDCP requires HDCP enabled devices which has a set of secret keys. During authentication, the receiving device will only accept content after it acknowledges the keys. To further protect the digital content, the transmitter and receiver generate a shared secret key value that is continuously checked throughout the transmission. After authentication is established, the transmitter encrypts the data and sends it to the receiver for decryption.

High-bandwidth transmission of digital content is usually achieved by one of two means: shielded copper wires (such as coaxial cable) or fiber optic cable. The first generation of HDCP transmission systems was known of using parallel shielded copper wire cables, such as DVI cables or HDMI cables.

However, the bandwidth of this kind of cable has limitations in transmitting data. When the distance of transmission is elongated, the cost of the shielded copper wire cable will increase and the transmitted data will decay rapidly. In view of this fact, a multiple parallel optical fiber link was introduced between transmitters and receivers. The optical systems of prior arts usually adopt at least two optical fiber links for HDCP applications. For instance, a four fiber module configuration has three forward channels and one backward channel, and it requires four lasers or other like light sources, four optical fiber links, and four receivers. Similarly, a six fiber module configuration has five forward channels and one backward channel, and it requires six lasers, six optical fiber links, and six receivers. For longer distance applications under the configurations, the cost of multiple parallel optical fibers is a concern, and the arrangement and maintenance of the multiple parallel optical fibers must increase the loading.

Accordingly, one scope of the invention is to provide a data transmission apparatus which transmits data only via one optical fiber. The bidirectional data transmissions of the data transmission apparatus are HDCP-based, and thereby the quantity and the cost of optical devices can be decreased to reduce the arrangement and maintenance of optical fibers.

### SUMMARY OF THE INVENTION

According to the bidirectional HDCP-based data transmission apparatus using an optical fiber of a preferred embodiment of the invention, the optical fiber includes a core having a first facet and a second facet. The bidirectional HDCP-based data transmission apparatus includes a forward transmission module and a backward transmission module. The forward transmission module is optically coupled to the first facet of the core of the optical fiber. The forward transmission module is used for emitting at least two forward light signals into the first facet of the core when being driven. The at least two forward light signals are then transmitted over the optical fiber. One of the at least two forward light signals is associated with HDCP data. The backward transmission module is optically coupled to the second facet of the core of the optical fiber. The backward transmission module is used for receiving the at least two forward light signals transmitted over the optical fiber, and emitting at least one backward light signal into the second facet of the core when being driven. The at least one backward light signal is then transmitted over the optical fiber. The at least one backward light signal is associated with HDCP data. The forward transmission module also receives the at least one backward light signal transmitted over the optical fiber.

According to the bidirectional HDCP-based data transmission apparatus using an optical fiber of another preferred embodiment of the invention, the optical fiber includes a core having a first facet and a second facet. The bidirectional HDCP-based data transmission apparatus includes a forward transmission module and a backward transmission module. The forward transmission module includes a first processing device, a first light emitter, and a first photodetector. The first processing device is used for receiving at least two forward electric signals associated with HDCP data, and transforming the at least two forward electric signals into a serial forward electric signal. The first light emitter is electrically connected to the first processing device and optically coupled to the first facet of the core of the optical fiber. The first light emitter is used for emitting, driven by the serial forward electric signal, a forward light signal into the first facet of the core. The forward light signal is then transmitted over the optical fiber. The first photodetector is electrically connected to the first processing device and optically coupled to the first facet of the core of the optical fiber. The backward transmission module includes a second photodetector, a second processing device, and a second light emitter. The second photodetector is optically coupled to the second facet of the core of the optical fiber. The second photodetector is used for receiving the forward light signal transmitted over the optical fiber, and converting the forward light signal into the serial forward electric signal. The second processing device is electrically connected to the second photodetector to receive the serial forward electric signal, and to interpret the serial forward electric signal into the at least two forward electric signals associated with the HDCP data. The second processing device also receives at least one backward electric signal, and transforms the at least one backward electric signal into a serial backward electric signal. The second light emitter is electrically connected to the second processing device and optically coupled to the second facet of the core of the optical fiber. The second light emitter is used for emitting, driven by the serial backward electric signal, a backward light signal into the second facet of the core. The backward light signal is then transmitted over the optical fiber. The first photodetector receives the backward light signal transmitted over the optical fiber, and converts the backward light signal into the serial backward electric signal. The first processing device receives the serial backward electric signal, and interprets the serial backward electric signal into the at least one backward electric signal. Wherein one of the at least two forward electric signals and the at least one backward electric signal include a protection scheme electrical signal relative to the HDCP data.

Accordingly, the data transmission apparatus according to the invention transmits data only via one optical fiber. The bidirectional data transmissions of the data transmission apparatus are HDCP-based, and thereby the quantity and the cost of optical devices can be decreased to reduce the arrangement and maintenance of optical fibers. In addition, the invention can be used in a bidirectional symmetrical transmitting mode or in a bidirectional asymmetrical mode because of the quantity of adopted light emitters. Furthermore, in order to optically couple light emitters to an optical fiber conveniently, the invention is capable of selectively transmitting data with only one light emitter.

The advantage and spirit of the invention may be understood by the following recitations together with the appended drawings.

### BRIEF DESCRIPTION OF THE APPFACETED DRAWINGS

FIG. 1 is a schematic diagram illustrating a bidirectional HDCP-based data transmission apparatus according to a preferred embodiment of the invention.

FIG. 2A is a schematic diagram illustrating the forward transmission module in FIG. 1.

FIG. 2B is a schematic diagram illustrating the backward transmission module in FIG. 1.

FIG. 3 is a schematic diagram illustrating a bidirectional HDCP-based data transmission apparatus according to another preferred embodiment of the invention.

### DETAILED DESCRIPTION OF THE INVENTION

The scope of the invention is to provide a bidirectional HDCP-based data transmission apparatus. The bidirectional HDCP-based data transmission apparatus according to the invention transmits data only via one optical fiber, and thereby the quantity and the cost of optical devices can be decreased to reduce the arrangement and maintenance of optical fibers. The spirit and feature of the present invention will be described in detail by the following preferred embodiments.

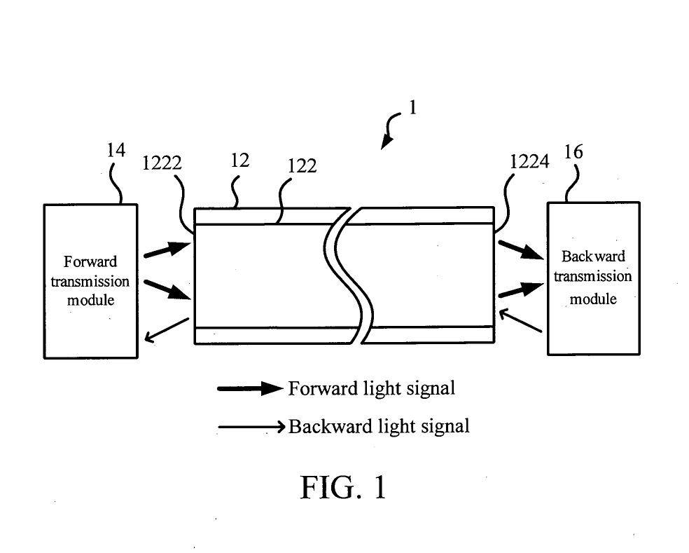

Please refer to FIG. 1. FIG. 1 is a schematic diagram illustrating a bidirectional HDCP-based data transmission apparatus 1 according to a preferred embodiment of the invention. As shown in FIG. 1, the bidirectional HDCP-based data transmission apparatus 1 according to a preferred embodiment of the invention uses an optical fiber 12. The optical fiber 12 includes a core 122 having a first facet 1222 and a second facet 1224. The bidirectional HDCP-based data transmission apparatus 1 includes a forward transmission module 14 and a backward transmission module 16.

As shown in FIG. 1, the forward transmission module 14 is optically coupled to the first facet 1222 of the core 122 of the optical fiber 12. The backward transmission module 16 is optically coupled to the second facet 1224 of the core 122 of the optical fiber 12.

Also shown in FIG. 1, the forward transmission module 14 is used for emitting at least two forward light signals into the first facet 1222 of the core 122 when being driven. The at least two forward light signals are then transmitted over the optical fiber 12. One of the at least two forward light signals is associated with HDCP data. The backward transmission module 16 is used for receiving the at least two forward light signals transmitted over the optical fiber 12, and emitting at least one backward light signal into the second facet 1224 of the core 122 when being driven. The at least one backward light signal is then transmitted over the optical fiber 12. The forward transmission module 14 also receives the at least one backward light signal transmitted over the optical fiber 12, and the at least one backward light signal includes a protection scheme light signal 1622 relative to the HDCP data.

In a practical application, the forward transmission module 14 of the bidirectional HDCP-based data transmission apparatus 1 can be included in an audio and high definition (HD) video mediator, and the backward transmission module 16 can be included in a high definition display panel and speaker system. In a home entertainment system application, for instance, the audio and high definition video mediator can be a DVD player, a computer, or a set-top box, and the high definition display panel and speaker system can be a high definition or digital television, a monitor, or a projector. A user can use the system to play movies, music, and the like.

In general, the audio and high definition video mediator can be any device or system that can output digital audio and/or video data that is content protected, and the high definition display panel and speaker system can be any device or system that can display and/or sound the digital content transmitted from the audio and high definition video mediator. Audio content includes, for instant, music, video sound tracks, audio books, machine messages (e.g., coded binary message for machine to machine communication), and human messages. Video content includes digital video, as well as other visual content such as presentation slides, graphical images, and digital art.

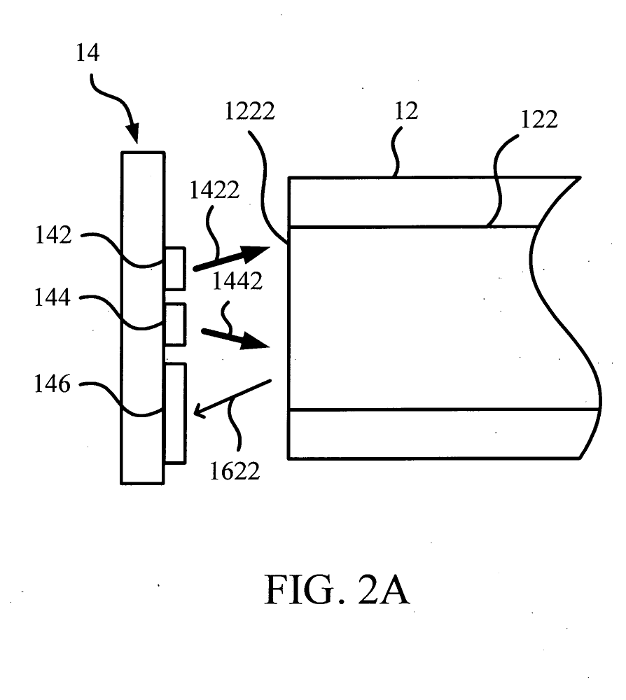

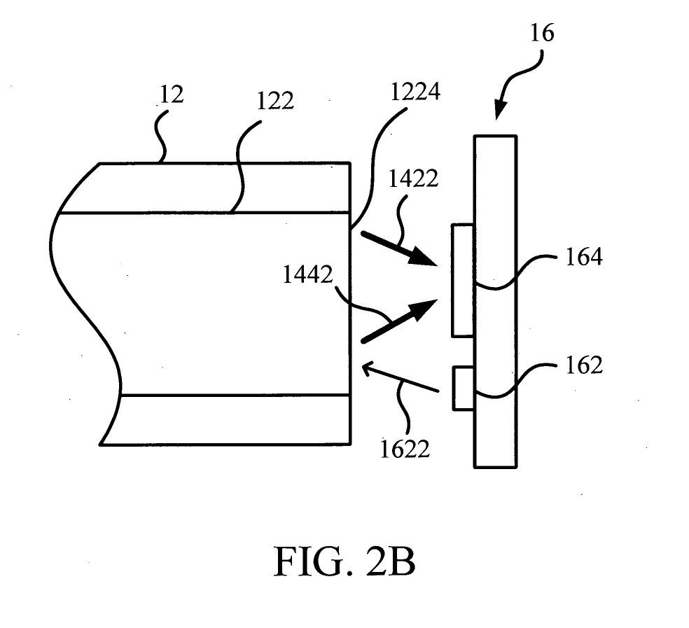

Please refer to FIG. 2A. FIG. 2A is a schematic diagram illustrating the forward transmission module 14 in FIG. 1. As shown in FIG. 2A, in an embodiment, the at least two forward light signals include a first forward light signal 1422 and a second forward light signal 1442. The forward transmission module 14 includes a first light emitter 142 and a second light emitter 144.

As shown in FIG. 2A, the first light emitter 142 is optically coupled to the first facet 1222 of the core 122 of the optical fiber 12. The first light emitter 142 is used for emitting the first forward light signal 1422 into the first facet 1222 of the core 122 when being driven. Similarly, the second light emitter 144 is optically coupled to the first facet 1222 of the core 122 of the optical fiber 12. The second light emitter 144 is used for emitting the second forward light signal 1442 into the first facet 1222 of the core 122 when being driven.

Also shown in FIG. 2A, in the embodiment, the forward transmission module 14 further includes a first photodetector 146. The first photodetector 146 is optically coupled to the first facet 1222 of the core 122 of the optical fiber 12. The first photodetector 146 is used for receiving the protection scheme light signal 1622 transmitted over the optical fiber 12.

In order to protect the integrity of the digital audio/video content as being transmitted, in an embodiment, the formats of the first forward light signal 1422, the second forward light signal 1442, and the protection scheme light signal 1622 comply with HDCP specification. Hereby, the integrity of the digital audio/video content as being transmitted can be protected by an authentication handshake and encryption of HDCP.

Please refer to FIG. 2B. FIG. 2B is a schematic diagram illustrating the backward transmission module 16 in FIG. 1. As shown in FIG. 2B, in an embodiment, the backward transmission module 16 includes a third light emitter 162 and a second photodetector 164.

As shown in FIG. 2B, the third light emitter 162 is optically coupled to the second facet 1224 of the core 122 of the optical fiber 12. The third light emitter 162 is used for emitting the protection scheme light signal 1622 into the second facet 1224 of the core 122 when being driven. The second photodetector 164 is optically coupled to the second facet 1224 of the core 122 of the optical fiber 12. The second photodetector 164 is used for receiving the first forward light signal 1422 and the second forward light signal 1442 transmitted over the optical fiber 12.

In an embodiment, the first forward light signal 1422 and the second forward light signal 1442 are in the range of 800 nm to 1600 nm at a modulation level of 1 GHz or greater, and the protection scheme light signal 1622 is in the range of 400 nm to 750 nm at a modulation level of 10 MHz or less. Therefore, HDCP is used to deliver uncompressed digital audio and/or video content using a high speed forward transmission (e.g., >1 Giga-bit/s) of a fiber.

Relatively, in the embodiment, the frequency of the first forward light signal 1422 is in a GHz range, the frequency of the second forward light signal 1442 is in a GHz range and differs from that of the first forward light signal 1422, and the frequency of the protection scheme light signal 1622 is in a MHz range. Therefore, the first light emitter 142 can be a first laser diode, the second light emitter 144 can be a second laser diode, and the third light emitter 162 can be a light emitting diode.

And, in the embodiment, the first laser diode can adopt a laser diode with a wavelength of 1310 nm, and the second laser diode can adopt a laser diode with a wavelength of 1550 nm.

In order to transmit additional control signals via the optical fiber 12, in an embodiment, the backward light signal can include a control light signal (such as a control signal of a remote control of a television). The backward transmission module 16 can further selectively include a fourth light emitter. The fourth light emitter is optically coupled to the second facet 1224 of the core 122 of the optical fiber 12. The fourth light emitter is used for emitting the control light signal into the second facet 1224 of the core 122 when being driven. The control light signal is then transmitted over the optical fiber 12. Hereby, the first photodetector 146 receives the control light signal transmitted over the optical fiber 12.

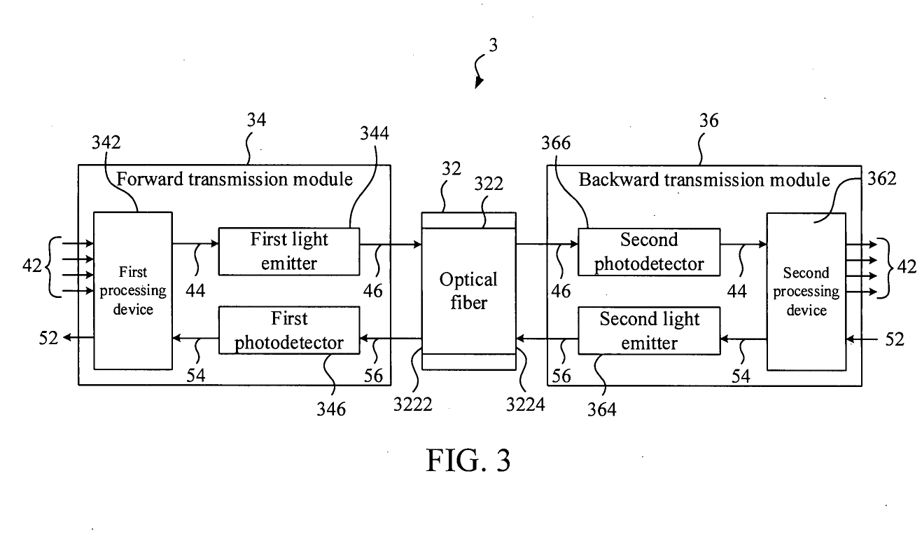

In addition, please refer to FIG. 3. FIG. 3 is a schematic diagram illustrating a bidirectional HDCP-based data transmission apparatus 1 according to another preferred embodiment of the invention. As shown in FIG. 3, the bidirectional HDCP-based data transmission apparatus 1 according to the invention uses an optical fiber 32. The optical fiber 32 includes a core 322 having a first facet 3222 and a second facet 3224. The bidirectional HDCP-based data transmission apparatus 1 includes a forward transmission module 34 and a backward transmission module 36.

As shown in FIG. 3, the forward transmission module 34 includes a first processing device 342, a first light emitter 344, and a first photodetector 346. The backward transmission module 36 includes a second processing device 362, a second light emitter 364, and a second photodetector 366.

Also shown in FIG. 3, the first processing device 342 is used for receiving at least two forward electric signals 42 associated with HDCP data, and transforming the at least two forward electric signals 42 into a serial forward electric signal 44.

Also shown in FIG. 3, the first light emitter 344 is electrically connected to the first processing device 342 and optically coupled to the first facet 3222 of the core 322 of the optical fiber 32. The first light emitter 344 is used for emitting, driven by the first processing device 342 in accordance with the serial forward electric signal 44, a forward light signal 46 into the first facet 3222 of the core 322. The forward light signal 46 is then transmitted over the optical fiber 32.

Also shown in FIG. 3, the second photodetector 366 is optically coupled to the second facet 3224 of the core 322 of the optical fiber 32. The second photodetector 366 is used for receiving the forward light signal 46 transmitted over the optical fiber 32, and converting the forward light signal 46 into the serial forward electric signal 44.

Also shown in FIG. 3, the second processing device 362 is electrically connected to the second photodetector 366. The second processing device 362 is used for receiving the serial forward electric signal 44, and interpreting the serial forward electric signal 44 into the at least two forward electric signals 42 associated with the HDCP data. Moreover, the second processing device 362 also receives at least one backward electric signal 52, and transforms the at least one backward electric signal 52 into a serial backward electric signal 54.

Also shown in FIG. 3, the second light emitter 364 is electrically connected to the second processing device 362 and optically coupled to the second facet 3224 of the core 322 of the optical fiber 32. The second light emitter 364 is used for emitting, driven by the second processing device 362 in accordance with the serial backward electric signal 54, a backward light signal 56 into the second facet 3224 of the core 322. The backward light signal 56 is then transmitted over the optical fiber 32.

Also shown in FIG. 3, the first photodetector 346 is electrically connected to the first processing device 342 and optically coupled to the first facet 3222 of the core 322 of the optical fiber 32. The first photodetector 346 is used for receiving the backward light signal 56 transmitted over the optical fiber 32, and converting the backward light signal 56 into the serial backward electric signal 54.

Also shown in FIG. 3, the first processing device 342 receives the serial backward electric signal 54, and interprets the serial backward electric signal 54 into the at least one backward electric signal 52. The at least one backward electric signal 52 includes a protection scheme electrical signal relative to the HDCP data.

In an embodiment, the first processing device 342 and the second processing device 362 are MUX/DEMUXs.

Furthermore, in an embodiment, the active areas of the first photodetector 146 and the second photodetector 164 are about 80 to 100 microns across (e.g., square, circular, or irregular shape), and the core 122 of the optical fiber 12 is about 62.5 microns in diameter. It is notable that the active areas of the first photodetector 146 and the second photodetector 164 can be larger (e.g., 100 to 500 microns across, or more).

Moreover, it is notable that in order to transmit data with Giga-bit/s range (such as uncompressed video stream), the bidirectional HDCP-based data transmission apparatus 1 of the invention can adopt glass optical fiber to transmit data.

It is certain that the bidirectional HDCP-based data transmission apparatus 1 of the invention can be applied to other protection scheme applications. For instant, the forward transmission module 14 can be used to deliver payload data, while the backward transmission module 16 can be used to deliver link management or overhead information, such as transmission statistics (e.g., amount of payload delivered and transmission time) and customer data (e.g., credit card info, movie selection, and subscriber feedback).

Compared with prior arts, the data transmission apparatus according to the invention transmits data only via one optical fiber. The bidirectional data transmissions of the data transmission apparatus are HDCP-based, and thereby the quantity and the cost of optical devices can be decreased to reduce the arrangement and maintenance of optical fibers. In addition, the invention can apply two, three, or more than four light emitters in a bidirectional symmetrical transmitting mode or in a bidirectional asymmetrical mode because of the quantity of adopted light emitters. Thus, when the data required of being transmitted becomes larger, the problem of the insufficiency of transmitting data only by a light emitter will be solved. Moreover, in order to optically couple light emitters to an optical fiber conveniently, the invention can further use MUX/DEMUXs to transmit data with only one light emitter.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A bidirectional HDCP-based data transmission apparatus using an optical fiber comprising a core having a first facet and a second facet, said bidirectional HDCP-based data transmission apparatus comprising:
a forward transmission module, optically coupled to the first facet of the core of the optical fiber, for emitting at least two forward light signals associated with HDCP data into the first facet of the core when being driven, the at least two forward light signals being then transmitted over the optical fiber; and
a backward transmission module, optically coupled to the second facet of the core of the optical fiber, for receiving the at least two forward light signals transmitted over the optical fiber, and emitting at least one backward light signal into the second facet of the core when being driven, the at least one backward light signal being then transmitted over the optical fiber, wherein the forward transmission module also receives the at least one backward light signal transmitted over the optical fiber, and the at least one backward light signal comprises a protection scheme light signal relative to the HDCP data.

2. The bidirectional HDCP-based data transmission apparatus of claim 1, wherein the at least two forward light signals comprise a first forward light signal and a second forward light signal, the forward transmission module comprises:
a first light emitter, optically coupled to the first facet of the core of the optical fiber, for emitting the first forward light signal into the first facet of the core when being driven; and
a second light emitter, optically coupled to the first facet of the core of the optical fiber, for emitting the second forward light signal into the first facet of the core when being driven.

3. The bidirectional HDCP-based data transmission apparatus of claim 2, wherein the forward transmission module further comprises a first photodetector, optically coupled to the first facet of the core of the optical fiber, for receiving the protection scheme light signal transmitted over the optical fiber.

4. The bidirectional HDCP-based data transmission apparatus of claim 3, wherein the backward transmission module comprises:
a third light emitter, optically coupled to the second facet of the core of the optical fiber, for emitting the protection scheme light signal into the second facet of the core when being driven; and
a second photodetector, optically coupled to the second facet of the core of the optical fiber, for receiving the first forward light signal and the second forward light signal transmitted over the optical fiber.

5. The bidirectional HDCP-based data transmission apparatus of claim 4, wherein the frequency of the first forward light signal is in a GHz range, the frequency of the second forward light signal is in a GHz range and differs from that of the first forward light signal, and the frequency of the protection scheme light signal is in a MHz range.

6. The bidirectional HDCP-based data transmission apparatus of claim 5, wherein the first forward light signal and the second forward light signal are in the range of 800 nm to 1600 nm at a modulation level of 1 GHz or greater, and the protection scheme light signal is in the range of 400 nm to 750 nm at a modulation level of 10 MHz or less.

7. The bidirectional HDCP-based data transmission apparatus of claim 4, wherein the first light emitter is a first laser diode, the second light emitter is a second laser diode, and the third light emitter is a light emitting diode.

8. The bidirectional HDCP-based data transmission apparatus of claim 4, wherein the at least one backward light signal also comprises a control light signal, the backward transmission module further comprises a fourth light emitter, optically coupled to the second facet of the core of the optical fiber, for emitting the control light signal into the second facet of the core when being driven, the control light signal is then transmitted over the optical fiber, the first photodetector also receives the control light signal transmitted over the optical fiber.

9. A bidirectional HDCP-based data transmission apparatus using an optical fiber comprising a core having a first facet and a second facet, said bidirectional HDCP-based data transmission apparatus comprising:
a forward transmission module, comprising:
a first processing device, for receiving at least two forward electric signals associated with HDCP data, and transforming the at least two forward electric signals into a serial forward electric signal;
a first light emitter, electrically connected to the first processing device and optically coupled to the first facet of the core of the optical fiber, for emitting, driven by the first processing device in accordance with the serial forward electric signal, a forward light signal into the first facet of the core, the forward light signal being then transmitted over the optical fiber; and
a first photodetector being electrically connected to the first processing device and optically coupled to the first facet of the core of the optical fiber; and
a backward transmission module, comprising:
a second photodetector, optically coupled to the second facet of the core of the optical fiber, for receiving the forward light signal transmitted over the optical fiber, and converting the forward light signal into the serial forward electric signal;
a second processing device, electrically connected to the second photodetector, for receiving the serial forward electric signal, interpreting the serial forward electric signal into the at least two forward electric signals associated with the HDCP data, receiving at least one backward electric signal, and transforming the at least one backward electric signal into a serial backward electric signal; and
a second light emitter, electrically connected to the second processing device and optically coupled to the second facet of the core of the optical fiber, for emitting, driven by the second processing device in accordance with the serial backward electric signal, a backward light signal into the second facet of the core, the backward light signal being then transmitted over the optical fiber;
wherein the first photodetector receives the backward light signal transmitted over the optical fiber, and converts the backward light signal into the serial backward electric signal; and
wherein the first processing device receives the serial backward electric signal, and interprets the serial backward electric signal into the at least one backward electric signal comprising a protection scheme electrical signal relative to the HDCP data.

10. The bidirectional HDCP-based data transmission apparatus of claim 9, wherein the first processing device and the second processing device are MUX/DEMUXs.

11. The bidirectional HDCP-based data transmission apparatus of claim 9, wherein the first light emitter is a first laser diode and the second light emitter is a second laser diode.

12. The bidirectional HDCP-based data transmission apparatus of claim 9, wherein the at least one backward electric signal also comprises a control electric signal.
